(19) United States
(12) Patent Application Publication
(10) Pub. No.: US 2015/0224489 A1
(43) Pub. Date: Aug. 13, 2015

(54) USE OF HEAVY DARK OIL COMPONENTS AS CATALYST IN OXIDATIVE PURIFICATION OF HYDROCARBON COMPOSITIONS FROM HYDROGEN SULPHIDE AND LIGHT MERCAPTANS, CATALYST BASED OF HEAVY DARK OIL COMPONENTS FROM HYDROGEN SULPHIDE AND LIGHT MERCAPTANS

(71) Applicants: Sergei Chernishov, Naro-Fominsk (RU); Alexei Konovalov, Moscovskaya obl. (RU); Anatoly Bishir, Kishinev (MD); Ivan Lesnik, Edinits (MD); Irina Tarkhanova, Moscow (RU)

(72) Inventors: Sergei Chernishov, Naro-Fominsk (RU); Alexei Konovalov, Moscovskaya obl. (RU); Anatoly Bishir, Kishinev (MD); Ivan Lesnik, Edinits (MD); Irina Tarkhanova, Moscow (RU)

(21) Appl. No.: 14/410,971

(22) PCT Filed: Jun. 21, 2013
(86) PCT No.: PCT/IB2013/001318

§ 371 Date: Dec. 23, 2014

(30) Foreign Application Priority Data
Jun. 26, 2012 (MD) 2012 0057

(51) Int. Cl. B01J 31/22; B01J 31/12; C10G 27/10

(52) U.S. Cl. CPC B01J 31/22; C10G 27/10; B01J 31/12; B01J 2531/16; B01J 2531/56

(57) ABSTRACT

Use of heavy dark components of oil, whose residue after distillation of fractions boiling out under 350 deg.C. contains copper and vanadium total not less than 0.005 mass % counted on pure metal, as a catalyst during oxidative purification of hydrocarbon compositions from hydrogen sulphide and light mercaptans. The catalyst is selected from heavy dark components of oil. A method of purification of hydrocarbon compositions from hydrogen sulphide and light mercaptans by its oxidation with air oxygen or oxygen-containing gas at temperatures from 55 deg.C. to 135 deg.C. in presence, as a catalyst, of heavy dark components of oil, whose residue after distillation of fractions boiling out up to 350 deg.C. contains copper and vanadium total not less than 0.005 mass % counted on pure metal.

### TECHNICAL FIELD

The invention relates to oxidative purification of hydrocarbon compositions from hydrogen sulphide and light mercaptans in presence of catalyst and can be used in oil, gas, oil-processing, oil-chemical and other industrial areas.

### BACKGROUND ART

Methods of oxidative purification of liquid hydrocarbon compositions by processing of a raw material with air oxygen with use of alkali solution in presence of continuously introduced catalytic complex are known.

It is known to use a catalytic complex [1] and [2] into which phthalocyanine derivatives of cobalt are introduced.

Use of a catalytic complex [3] into which nitrogen-containing base reagents are introduced in combination with water-soluble salt of metals with variable valency is also known.

Use of a catalytic complex [4] is known, into which nitrogen-containing reagents are introduced in combination with phthalocyanines.

Main disadvantage of the use of these catalysts is a necessity to deactivate sulfide-alkali sewers.

Method [5] which combines physical and chemical purification-concentration of hydrocarbon and light mercaptans is known, by desorption in gas phase by blowing off hydrocarbon gas with subsequent neutralization of residual quantity of hydrogen sulphide and mercaptans with use of reagents.

Disadvantage of this method is loss of low-boiling benzene components with gas and high consumption of reagents-absorbents.

Method [6] including removal of components in form of concentrate by hydrocycloning of oil with subsequent their removal by reagent-neutralizer can be considered as belonging to the same type of purification.

In known methods [7], [8] and [9] nitrogen-containing organic compositions are used as neutralizers.

Disadvantage of these methods is high consumption of reagents-neutralizers.

It is known that complexes of transitional metals with nitrogen-containing heterocycles are catalysts of oxidation of hydrogen sulphide and mercaptans.

A method of purification of hydrocarbon compositions [10] is known with use as a catalyst a complex of general formula CuII Cl 1-2 (L) 1-2 where L is a derivative of pyridine, in individual form or applied on a mineral carrier (silica or alumosilicate). This metallocomplex is synthesized from CuCl or CuCl2 and corresponding heterocyclic composition by mixing reagents in acetone nitril or alcohol. For synthesis of immobilized metallocomplex hydroxyalkyl pyridine is preliminarily applied on a surface of the carrier by impregnation from a solution of acetonitril and alcohol, and then the modified carrier is introduced into a reaction with copper salt in a corresponding solvent. The catalyst actively oxidizes mercaptans and hydrogen sulphide by air oxygen at temperature 20-80 deg. C. and atmospheric pressure.

Method [11] is known for purification of hydrogen sulphide with use of homogenous catalytic composition, containing copper chloride or copper bromide (II) solvating organic additives from a row of nitrogen-containing heterocyclic compositions or alkylamides with linear or cyclic structure, alcohol (C1-C3) and water. Catalyst is dissolved in oil raw material (kerosene, gas condensate) or one- or two atom alcohol (for example, alcohol C1-C3 or ethylene glycol), or in water-alcohol mixture. The obtained solution catalyzes oxidation of hydrocarbon by oxygen or air at temperature 20-50 deg. C. and atmospheric pressure with formation of elementary sulfur.

Disadvantages of these methods are high cost of derivatives of pyridine and high consumption of solvents.

The closest method to the claimed method is method [12] disclosed in patent RF No. 2167187 for purification of oil and oil products from hydrocarbon by its oxidation with air oxygen in presence of nitrogen-containing base and/or alkali reagent, taken on account of not less than 0.2 mol per 1 mol of hydrocarbon and a water-soluble salt of metal of variable valency, which is used in form of water-alkali solution.

Disadvantage of this method is high consumption of nitrogen containing basic reagent, and also necessity to use salts of heavy metals and water solutions of alkali.

### SUMMARY OF THE INVENTION

It is an object of the invention to simplify technology or purification of hydrocarbon compositions from hydrogen sulphide and light mercaptans by use of natural catalytic properties of oil and its components.

In accordance with the invention the disadvantages of the above-described methods of purification of hydrocarbon compositions from hydrogen sulphide are eliminated by heating hydrocarbon composition to temperature 55-135 deg. C. in presence of dissolved in it oxygen and heavy dark components of oil, whose residue after distillation of fractions boiling up to 350 deg. C., contains compositions of copper and/or vanadium in quantity not less than 0.005 mass % counted on pure metal. The dark components of oil perform the function of a catalyst.

It is known that heavy dark residues of oil processing contain nitrogen-containing compositions, including heterocycles, and composition of metals with variable valency—copper and vanadium (“Chemistry of Oil and Gas”. Textbook, 1995, S.-P. Chemistry. P. 446). Content of the above mentioned metals in dark residues of oil processing, in particular, in fuel oil (residue after distillation of fractions boiling out at up to 350 deg. C.) depends on nature of oil and can reach 0.02 mass %. With the use of effective quantity of these substances it is possible to obtain a catalytic composition for oxidation of hydrogen sulphide and light mercaptans by its oxidation with air oxygen or oxygen-containing gas at temperature 55-135 deg. C. Used fuel oil (residue after distillation of fractions boiling out up to 350 deg. C.) must contain compositions of transitional metals—copper or vanadium—with total quantity not less than 0.005 mass % counted on pure metal. If the total quantity of copper or vanadium in the above mentioned residue is less than the above specified, its catalytic activity sharply diminishes.

For efficient running of the process all above-mentioned components and its conditions are equally necessary. The above mentioned content of transitional metals is necessary, since with its lower concentration catalytic activity of the above mentioned components sharply diminishes. Lowering of temperature below 55 deg. C. leads to sharp reduction of speed of oxidation of hydrocarbon. Increasing of temperature above 135 deg. C leads to an increase of probability of running a reverse reaction—formation of hydrogen sulphide due to interaction of sulfur with organic sources of hydrogen. The necessary condition of running the process is presence of dissolved oxygen is hydrocarbon composition subjected to purification.

Quantity of oxygen-containing gas depends on raw material to be purified and is determined from equations

2H2S+02=2S+2H20

i.e for 2 mol of hydrogen sulphide 1 mol of oxygen during purification from hydrogen sulphide, and

4RSH+02 =2RSSR+2H20

i.e. for 4 mol of mercaptan 1 mol of oxygen during purification from mercaptan.

Method of oxygen supply into a reaction zone depends on specific oil product: a preliminary saturation by oxygen of a raw material to be purified, and dosing of air or air-containing gas directly into a stream of a raw material are possible.

The proposed method can be carried out with use of capacity equipment and/or a pipeline as an oxidation reactor.

### BRIEF DESCRIPTION OF THE DRAWINGS

FIG. 1 of the drawings is a view showing a diagram of a process presented as Example 5 hereinbelow.

### EXAMPLES

The invention is illustrated by the following examples.

### Example 1

A reactor with volume 750 ml is charged with 500 ml of diesel fraction, which contains 0.01 mass % of hydrogen sulphide, and then 100 ml of directly distilled fuel oil which contains vanadium and copper with total content of the metals 0.005 mass % and purified from hydrocarbon (thereafter “fuel oil”) is introduced. Then the reactor is hermetically closed and air is pumped until pressure of 2 atm. is reached. The process is conducted with thermostating and mixing during 30 min. at temperature 90 deg. C. After finishing of the process the reactor is cooled to room temperature.

The cooled hydrocarbon composition was analyzed for content of hydrogen sulphide by method of potentiometric titration in accordance with GOST 17323-71. The content of hydrogen sulphide in the composition was less than 1 ppm.

### Example 2

A reactor with volume of 750 mi was charged with 300 gr of diesel fraction which contains 0.01 mass % of hydrogen sulphide, and then 200 gr. of raw oil was introduced whose residue of distillation with boiling temperature above 350 deg. C. contains vanadium and copper in quantity 0.0051 mass % of metals. The introduced oil itself contains hydrogen sulphide in quantity 0.0052 mass %. A mixture of diesel fraction and oil obtained in the reaction was analyzed before beginning of the test as to content of hydrogen sulphide, and it happened to be equal to 0.008 mass %. Then the reactor was hermetically closed, and air was pumped for achieving pressure 3 atm.

The process was carried out with thermostating and mixing during 30 min at temperature 70 deg. C. After finishing the process the reactor is cooled to room temperature.

The cooled hydrocarbon composition was analyzed to determine content of hydrogen sulphide, which was less than 2 ppm.

### Example 3

A reactor with volume 750 ml is charged with 300 gr. of raw oil, whose residue of distillation with boiling temperature above 350 deg. C. contains vanadium and copper with total quantity of metals 0.0023 mass %. Then 200 gr. of raw oil is introduced, whose residue of distillation with boiling temperature above 350 deg. C. contains vanadium and copper with total quantity of metals 0.0063. The introduced oil itself contains hydrogen sulphide in quantity of 0.004 mass %. A mixture of two different samples of oil obtained in the reactor before the experiment was analyzed for content of hydrogen sulphide, which happened to be equal to 0.011 mass %. Then the reactor was hermetically closed and air was pumped until pressure of 5 atm was reached. The process was conducted with thermostating and mixing during 30 min at temperature 55 deg. C. After finishing the process the reactor was cooled to room temperature.

The cooled hydrocarbon composition was analyzed for content of hydrogen sulphide, whose quantity was less than 2 ppm.

### Example 4

A reactor with volume of 750 ml was charged with 400 gr. of gas condensate fuel oil (heavy residue of processing of gas condensate with boiling temperature of over 400 deg. C.), content of metals in the sample 0.0013 mass %, content of hydrogen sulphide 0.0067 mass %, content of methylmercaptans and ethylmercaptans 0.013 mass %. Then 150 ml of direct distillation fuel oil is introduced, which is free from hydrogen sulphide, methylmercaptans and ethylmercaptans and contains vanadium and copper with total quantity of metals 0.0058 mass %. Then the reactor is hermetically closed, and air is pumped until pressure of 2 atm is reached. The process is conducted with thermostating and mixing during 30 min at temperature 129 deg. C. After finishing of the process the reactor is cooled to room temperature. The cooled hydrocarbon composition was analyzed for content of hydrogen sulphide, methylmercaptans and ethylmercaptans. As a result of the analysis a content of hydrogen sulphide is determined—less than 2 ppm, with total content of methylmercaptans and ethylmercaptans less than 2 ppm.

### Example 5

3 normal liters of air are dissolved in fraction C3-C4 in quantity 1.5 kg with content of hydrogen sulphide 0.012 mass %.

The prepared composition is “frozen over” from vessel E1 to vessel E3, passing through vessel E2 provided with a siphon, heated on water bath, and containing about 1 kg of direct distillation fuel oil.

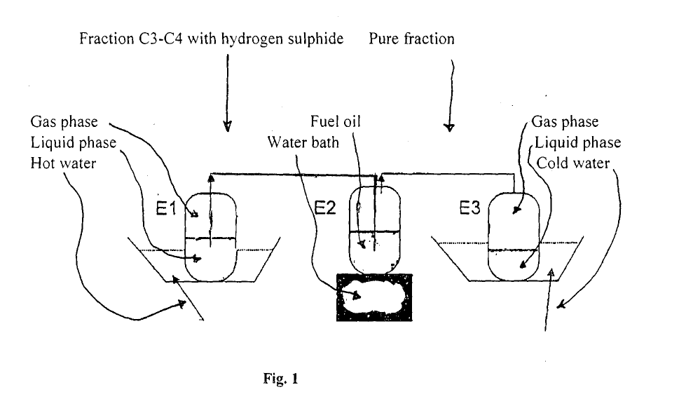

The diagram of conducting the process is presented on FIG. 1.

Fraction C3-C4 from the vessel E3 was analyzed (chromatographically) for content of hydrogen sulphide. The content of hydrogen sulphide in the fraction is less than 1 ppm. Analysis of fuel oil from the vessel E2 after finishing of the experiment also showed absence of hydrogen sulphide in it (less than 1 ppm). Direct distillation fuel oil is utilized in the experiment, with total content of copper and vanadium 0.0084 mass %.

### Examples Showing That Non-Use of Even One of Conditions Does Not Allow to Obtain Required Degree of Purification

### Example 6

Experiment is conducted as in Example 1, but without adding of direct distillation of fuel oil into a reactor.

The reactor with volume 750 ml is charged with 500 ml of diesel fraction, containing 0.01 mass % of hydrogen sulphide, then the reactor is hermetically closed and air pressure of 2 atm is produced. The process is conducted with thermostating and mixing during 30 min at temperature of 90 deg. C. After finishing of the process the reactor is cooled to room temperature.

The cooled hydrocarbon composition was analyzed for content of hydrogen sulphide with method of potentiometric titration in accordance with GOST 17323-71. Content of hydrogen sulphide in the composition was 85 ppm. (Part of hydrogen sulphide remained in gaseous phase of the reactor and was lost).

### Example 7

Experiment was conducted as in Example 1, but instead of direct distillation fuel oil containing vanadium and copper with total content of metals 0.005 mass %, direct distillation fuel oil containing vanadium and copper with total quantity of metals 0.0023 mass % was added.

The reactor with volume 750 ml was charged with 500 ml of diesel fraction, containing 0.01 mass % of hydrogen sulphide, then 100 ml of oil residue (fuel oil) is introduced with total content of vanadium and copper 0.0023 mass %. There is no hydrogen sulphide in the fuel oil. Then the reactor is hermetically closed, and air is pumped till 2 atm pressure is reached. The process is conducted with thermostating and mixing during 30 min at temperature of 90 deg. C. After finishing of the process the reactor is cooled to room temperature.

The cooled hydrocarbon composition was analyzed for content of hydrogen sulphide by method of potentiometric titration in accordance with GOST 17323-71. Content of hydrogen sulphide in the composition was 75 ppm.

### Example 8

The experiment was conducted as in Example 4. But without adding of direct distillation fuel oil.

The reactor with volume of 750 ml was charged with 400 gr. of gas condensate fuel oil (heavy residue of processing of gas condensate with boiling temperature above 400 deg. C.), content of metals in the sample 0.0013 mass %, content of hydrogen sulphide 0.0067 mass %, total content of methylmercapatans and ethylmercaptans 0.013 mass %. Then the reactor was hermetically closed and air was pumped until pressure of 2 atm was reached. The process is conducted with thermostating and mixing during 30 min at temperature 120 deg. C. After finishing the process the reactor is cooled to room temperature.

The cooled hydrocarbon composition was analyzed for content of hydrogen sulphide, methylmercaptans and ethylmercaptans. As a result of analysis it was determined that the content of hydrogen sulphide was 60 ppm, total content of methylmercaptans and ethylmercaptans was 120 ppm.

### Example 9

The experiment was conducted as in Example 4 but at temperature 40 deg. C.

The reactor with the volume of 750 ml was charged with 300 gr. of raw oil, whose distillation residue with boiling temperature above 350 deg. C. contains vanadium and copper with total quantity of metals 0.0023 mass %. Content of hydrogen sulphide in the sample was 0.015 mass %. Then 200 gr. of raw oil was introduced, whose residue of distillation with boiling temperature of above 350 deg. C. contains vanadium and copper with total quantity of metals 0.0063 mass %. A mixture of two different samples of oil is analyzed before beginning of the experiment for content of hydrogen sulphide, which was 0.011 mass %. Then the reactor is hermetically closed, and air is pumped to provide pressure of 5 atm, The process is conducted with thermostating and mixing during 30 min at temperature 40 deg. C. After finishing of the process the reactor is cooled to room temperature.

The cooled hydrocarbon composition was analyzed for content of hydrogen sulphide. As a result of the analysis it was determined that the content of hydrogen sulphide was 98 ppm.

### Example 10

The experiment was conducted as in Example 5, but no air is introduced into fraction C3-C4.

Vessel E1 before charging of fraction C3-C4 was blown through with nitrogen. The rest is as in Example 5.

After finishing of the process the content of hydrogen sulphide in fraction from E3 was 103 ppm.

The implementation of the proposed invention will make possible to stop using of catalysts which were used before or to significantly reduce their use, and also will make possible to simplify the method of purification of hydrocarbon compositions from hydrogen sulphide and light mercaptans.

1. RU 2087521

2. RU 21090033

3. RU 2167187

4. RU 2224006

5. RU 2218974

6. RU 2272066

7. RU 2173735

8. RU 2318864

9. RU 2372379

10. RU 2404225

11. RU 2398735

12. RU 2167187

1. A method of purification of hydrocarbon compositions from hydrogen sulphide and light mercaptans, comprising the step of using heavy dark components of oil with a boiling temperature above 350 deg. C. as a catalyst.

2. A method according to claim 1, wherein the heavy dark components of oil contain compositions of copper not less than 0.005 mass % counted on pure metal.

3. A method according to claim 1, wherein the heavy dark components of oil contain compositions of vanadium not less than 0.005 mass % counted on pure metal.

4. A method according to claim 4, wherein the heavy dark components of oil contain composition of copper and vanadium with total quantity not less than 0.005 mass % counted on pure metal.

5. A catalyst for purification of hydrocarbon composition from hydrogen sulphide and light mercaptans, containing complexes of transitional metals with nitrogen-containing heterocycles, characterized in that the catalyst is selected from residual dark products of processing of oil, in particular a residue after distillation of a fraction which boils out below 350 deg. C.

6. A catalyst according to claim 5, characterized in that it contains compositions of copper not less than 0.005 mass % counted on pure metal.

7. A catalyst according to claim 5, characterized in that it contains composition of vanadium not less than 0.005 mass % counted on pure metal.

8. A catalyst according to claim 5, characterized in that it contains composition of copper and vanadium with total quantity not less than 0.005 mass % counted on pure metal.

9. A method of oxidative purification of hydrocarbon compositions from hydrogen sulphide and light mercaptans in presence of a catalyst which contains complexes of transitional metals with nitrogen-containing heterocycles, characterized in that as a catalyst heavy dark components of oil are used with boiling temperature above 350 deg C., and a process of oxidation is conducted at temperature 55-135 deg. C. in presence of oxygen which is dissolved in the hydrocarbon composition.

10. A method according to claim 9, characterized in that the heavy dark components of oil contain composition of copper not less than 0.005 mass % counted on pure metal.

11. A method according to claim 9, characterized in that the heavy dark components of oil contain compositions of vanadium not less than 0.005 mass % counted on pure metal.

12. A method according to claim 9, characterized in that the heavy dark components of oil contain compositions of copper and vanadium with total quantity of not less than 0.005 mass % counted on pure metal.
